(19) United States
(12) Patent Application Publication
(10) Pub. No.: US 2025/0079540 A1
(43) Pub. Date: Mar. 6, 2025

(54) BATTERY MODULE

(71) Applicants: HYUNDAI MOTOR COMPANY, Seoul (KR); KIA CORPORATION, Seoul (KR); H GREEN POWER INC., Chungju-si (KR); HYUNDAI MOBIS CO., LTD., Seoul (KR)

(72) Inventors: Jun Young Lim, Seoul (KR); Jin Won Kim, Pyeongtaek-si (KR); Jun Seok Choi, Hwaseong-si (KR); Gun Tae Jung, Chungju-si (KR); Woo Hyung Kim, Chungju-si (KR); Jae Yeon Ryu, Chungju-si (KR); Jae Nyeon Kim, Chungju-si (KR); Jin Soo Park, Suwon-si (KR); Hyuk Geun Song, Suwon-si (KR)

(73) Assignees: HYUNDAI MOTOR COMPANY, Seoul (KR); KIA CORPORATION, Seoul (KR); H GREEN POWER INC., Chungju-si (KR); HYUNDAI MOBIS CO., LTD., Seoul (KR)

(21) Appl. No.: 18/649,539

(22) Filed: Apr. 29, 2024

(30) Foreign Application Priority Data
Sep. 6, 2023 (KR) 10-2023-0118624

(51) Int. Cl. H01M 10/48; H01M 10/42; H01M 50/244; H01M 50/264; H01M 50/287; H01M 50/474; H01M 50/503; H01M 50/507

(52) U.S. Cl. CPC H01M 10/482; H01M 10/425; H01M 50/244; H01M 50/264; H01M 50/287; H01M 50/474; H01M 50/503; H01M 50/507

(57) ABSTRACT

A battery module includes: a battery cell assembly having a plurality of battery cells stacked therein and a plurality of frames supporting the plurality of battery cells; a front sensing assembly measuring voltages of the plurality of battery cells and mounted on a front end of the battery cell assembly; a rear sensing assembly measuring voltages of the plurality of battery cells and mounted on a rear end of the battery cell assembly; a front cover covering at least a portion of the front sensing assembly; and a rear cover covering at least a portion of the rear sensing assembly.

### CROSS-REFERENCE TO RELATED APPLICATION

This application is based on and claims the benefit of priority to Korean Patent Application No. 10-2023-0118624, filed on Sep. 6, 2023, in the Korean Intellectual Property Office, the disclosure of which is incorporated herein in its entirety by reference.

### TECHNICAL FIELD

The present disclosure relates to a battery module, and more particularly, to a battery module designed to improve assemblability and productivity thereof.

### BACKGROUND

As is well-known in the art, a battery module may include a plurality of battery cells stacked therein. The plurality of battery cells may be connected in series or parallel.

A battery module according to the related art may include: a battery cell assembly having a plurality of battery cells and a plurality of frames supporting the plurality of battery cells; a sensing assembly sensing voltages of the plurality of battery cells; an upper housing mounted on top of the battery cell assembly; and a lower housing mounted on the bottom of the battery cell assembly.

According to the related art, each battery cell may be positioned and retained in the corresponding frame using positioning projections provided on the corresponding frame. However, since the positioning projections are integrally formed with and fixed to the frame, the size and structure of the battery cell may only be specified to the corresponding frame. Accordingly, the existing frame may only support the battery cell having particular specifications (size, structure, etc.). Thus, it cannot support a variety of battery cells having various specifications.

According to the related art, the sensing assembly may be inserted into the lower housing. The sensing assembly may have a sensing wire electrically connected to a front lead tab and a rear lead tab of each battery cell. During an assembly process of such elements, safety problems may occur due to compression of the sensing wire, incorrect insertion of the sensing wire, and the like.

According to the related art, the upper housing and the lower housing may be assembled to the top and bottom of the battery cell assembly. The upper housing and the lower housing may be fixed to the battery cell assembly using fasteners and the like so that assemblability and productivity of the battery module may be reduced.

The above information described in this background section is provided to assist in understanding the background of the inventive concept and may include any technical concept, which is not considered as prior art that is already known to those of ordinary skill in the art.

### SUMMARY

The present disclosure has been made to solve the above-mentioned problems occurring in the prior art while advantages achieved by the prior art are maintained intact.

An aspect of the present disclosure provides a battery module designed to improve assemblability and productivity thereof and to improve accuracy in sensing voltages of battery cells.

According to an aspect of the present disclosure, a battery module may include a battery cell assembly having a plurality of battery cells stacked therein and a plurality of frames supporting the plurality of stacked battery cells. The battery module may also include a front sensing assembly measuring voltages of the plurality of battery cells and mounted on a front end of the battery cell assembly. The battery module may also include a rear sensing assembly measuring voltages of the plurality of battery cells and mounted on a rear end of the battery cell assembly. The battery module may also include a front cover covering at least a portion of the front sensing assembly and a rear cover covering at least a portion of the rear sensing assembly.

The plurality of battery cells may include a first end battery cell, a second end battery cell located opposite the first end battery cell, and a plurality of middle battery cells stacked between the first end battery cell and the second end battery cell.

The plurality of frames may include a first end frame supporting the first end battery cell, a second end frame supporting the second end battery cell, and a plurality of middle frames supporting the plurality of middle battery cells.

The first end frame may have a plurality of supports supporting the first end battery cell. The plurality of supports may be spaced apart from each other by a predetermined gap in a longitudinal direction of the first end frame. The first end battery cell may be fixed to the first end frame by an adhesive layer applied to at least one of the plurality of supports.

The second end frame may have a plurality of supports supporting the second end battery cell. The plurality of supports may be spaced apart from each other by a predetermined gap in a longitudinal direction of the second end frame. The second end battery cell may be fixed to the second end frame by an adhesive layer applied to at least one of the plurality of supports.

The middle frame may have a plurality of supports supporting the middle battery cell. The plurality of supports may be spaced apart from each other by a predetermined gap in a longitudinal direction of the middle frame. The middle battery cell may be fixed to the middle frame by an adhesive layer applied to at least one of the plurality of supports.

The front sensing assembly may have a plurality of snap fit locks extending toward the front of the battery cell assembly. The plurality of snap fit locks may be snap-fitted to front hooks provided on the front of the battery cell assembly, respectively.

The front sensing assembly may include a front sensing body, a front sensing printed circuit board (PCB) mounted on the front sensing body, a front connector disposed on a central portion of the front sensing PCB, and a plurality of front sensing bus bars electrically connected to the front sensing PCB and the plurality of battery cells.

The front sensing body may include a front roof portion located above the front sensing PCB and the front roof portion may fully cover a top surface of the front connector.

The front sensing assembly may further include a first terminal block and a second terminal block provided on both left and right sides of the front roof portion, a first terminal fixed to the first terminal block; a second terminal fixed to the second terminal block, a first bus bar electrically connected to the first terminal, and a second bus bar electrically connected to the second terminal. The first bus bar and the second bus bar may be electrically connected to the plurality of battery cells.

The first bus bar may have a first contact bent downward from one edge thereof. An upper portion of the first contact may be embedded in the first terminal block. The first contact may be electrically connected to a front lead tab of the first end battery cell.

The second bus bar may have a second contact bent downward from one edge thereof. An upper portion of the second contact may be embedded in the second terminal block. The second contact may be electrically connected to a front lead tab of the second end battery cell.

The front sensing body may further include a first end guide rib guiding the front lead tab of the first end battery cell to the first contact and a second end guide rib guiding the front lead tab of the second end battery cell to the second contact.

The front sensing body may further include a plurality of middle guide ribs disposed between the first end guide rib and the second end guide rib. The plurality of front sensing bus bars may be disposed between the plurality of middle guide ribs.

The rear sensing assembly may have a plurality of snap fit locks extending toward the rear of the battery cell assembly. The plurality of snap fit locks may be snap-fitted to rear hooks provided on the rear of the battery cell assembly, respectively.

The rear sensing assembly may include a rear sensing body, a rear sensing PCB mounted on the rear sensing body, a rear connector disposed on a central portion of the rear sensing PCB, and a plurality of rear sensing bus bars electrically connected to the rear sensing PCB and the plurality of battery cells.

The rear sensing body may include a rear roof portion located above the rear sensing PCB and the rear roof portion may fully cover a top surface of the rear connector.

The rear sensing body may include a plurality of guide ribs guiding rear lead tabs of the plurality of battery cells. The plurality of rear sensing bus bars may be disposed between the plurality of guide ribs.

The front cover may be coupled to the front end of the battery cell assembly to cover at least a portion of the front sensing assembly. The front cover may have a plurality of snap fit locks extending toward the front of the battery cell assembly. The plurality of snap fit locks may be snap-fitted to front hooks provided on the front of the battery cell assembly, respectively.

The rear cover may be coupled to the rear end of the battery cell assembly to cover at least a portion of the rear sensing assembly. The rear cover may have a plurality of snap fit locks extending toward the rear of the battery cell assembly. The plurality of snap fit locks may be snap-fitted to rear hooks provided on the rear of the battery cell assembly, respectively.

The front cover may have a groove receiving a voltage sensing wire connected to the front sensing assembly.

### BRIEF DESCRIPTION OF THE DRAWINGS

The above and other objects, features, and advantages of the present disclosure should be more apparent from the following detailed description taken in conjunction with the accompanying drawings:

FIG. 1 illustrates a perspective view of a battery module according to an embodiment of the present disclosure;

FIG. 2 illustrates an exploded perspective view of a battery module according to an embodiment of the present disclosure;

FIG. 3 illustrates a perspective view of a battery cell assembly of a battery module according to an embodiment of the present disclosure;

FIG. 4 illustrates a view of the battery cell assembly, viewed in a direction indicated by arrow A, of FIG. 3;

FIG. 5 illustrates a perspective view of a first end frame and a second end frame of a battery module according to an embodiment of the present disclosure;

FIG. 6 illustrates a perspective view of a middle frame of a battery module according to an embodiment of the present disclosure;

FIG. 7 illustrates a first end battery cell and a first end frame of a battery module according to an embodiment of the present disclosure;

FIG. 8 illustrates a front view of a front sensing assembly of a battery module according to an embodiment of the present disclosure;

FIG. 9 illustrates a front view of the front sensing assembly illustrated in FIG. 8, from which a front sensing body has been removed;

FIG. 10 illustrates a rear view of a rear sensing assembly of a battery module according to an embodiment of the present disclosure;

FIG. 11 illustrates a front sensing assembly and a rear sensing assembly mounted on a battery cell assembly in a battery module according to an embodiment of the present disclosure;

FIG. 12 illustrates a state before a front sensing assembly is mounted on a front end of a battery cell assembly in a battery module according to an embodiment of the present disclosure;

FIG. 13 illustrates a front sensing assembly being mounted on a front end of a battery cell assembly in a battery module according to an embodiment of the present disclosure;

FIG. 14 illustrates a front sensing assembly completely mounted on a front end of a battery cell assembly in a battery module according to an embodiment of the present disclosure;

FIG. 15 illustrates a partially cut-away perspective view of a first end guide rib of a front sensing body in a battery module according to an embodiment of the present disclosure;

FIG. 16 illustrates a plan and cross-sectional view of a front sensing assembly and a rear sensing assembly mounted on a battery cell assembly in a battery module according to an embodiment of the present disclosure;

FIG. 17 illustrates an enlarged view of portion B of FIG. 16; and

FIG. 18 illustrates an enlarged view of portion C of FIG. 16.

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known techniques associated with the present disclosure have been omitted in order not to unnecessarily obscure the gist of the present disclosure.

Terms such as first, second, A, B, (a), and (b) may be used to describe the elements in embodiments of the present disclosure. These terms are only used to distinguish one element from another element. The intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings consistent with the contextual meanings in the relevant field of art. Such terms are not to be interpreted as having ideal or excessively formal meanings unless clearly defined as having such in the present application.

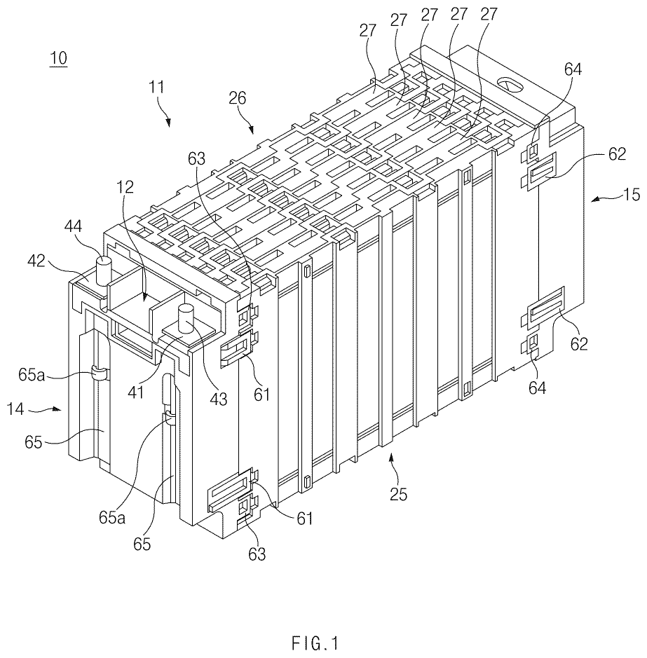

Referring to FIGS. 1-4, a battery module 10 according to an embodiment of the present disclosure may include a battery cell assembly 11, a front sensing assembly 12 mounted on a front end of the battery cell assembly 11, a rear sensing assembly 13 mounted on a rear end of the battery cell assembly 11, a front cover 14 covering at least a portion of the front sensing assembly 12, and a rear cover 15 covering at least a portion of the rear sensing assembly 13.

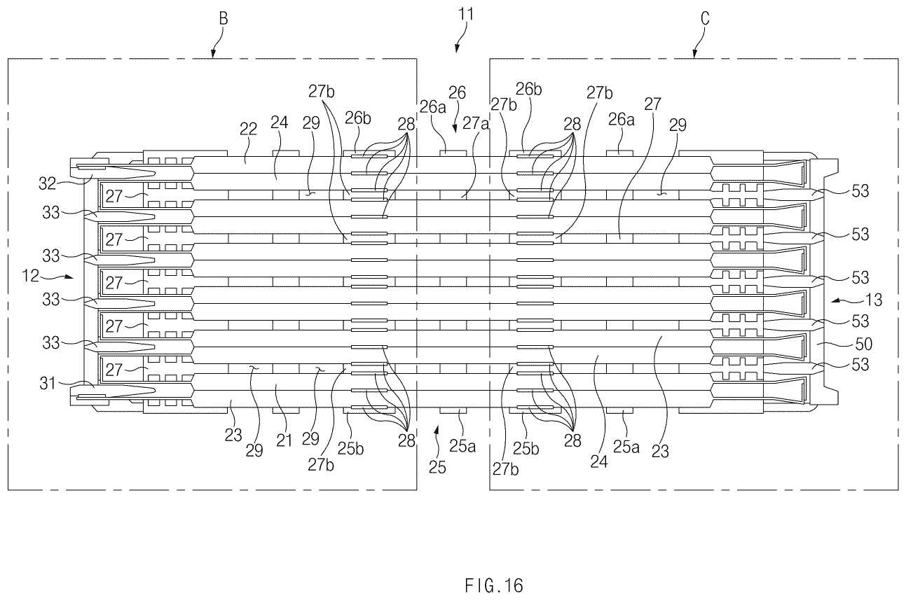

Referring to FIGS. 16, 17, and 18, the battery cell assembly 11 may include a plurality of battery cells 21, 22, 23, and 24 stacked side by side. The battery cell assembly 11 may also include a plurality of frames 25, 26, and 27 supporting the plurality of stacked battery cells 21, 22, 23, and 24.

The plurality of battery cells 21, 22, 23, and 24 may include a first end battery cell 21, a second end battery cell 22 located on the opposite of the first end battery cell 21, and a plurality of middle battery cells 23 and 24 stacked between the first end battery cell 21 and the second end battery cell 22.

The plurality of middle battery cells 23 and 24 may include a plurality of first middle battery cells 23 and a plurality of second middle battery cells 24 alternately arranged between the first end battery cell 21 and the second end battery cell 22.

The first end battery cell 21, the plurality of middle battery cells 23 and 24. The second end battery cell 22 may be electrically connected to each other through respective lead tabs.

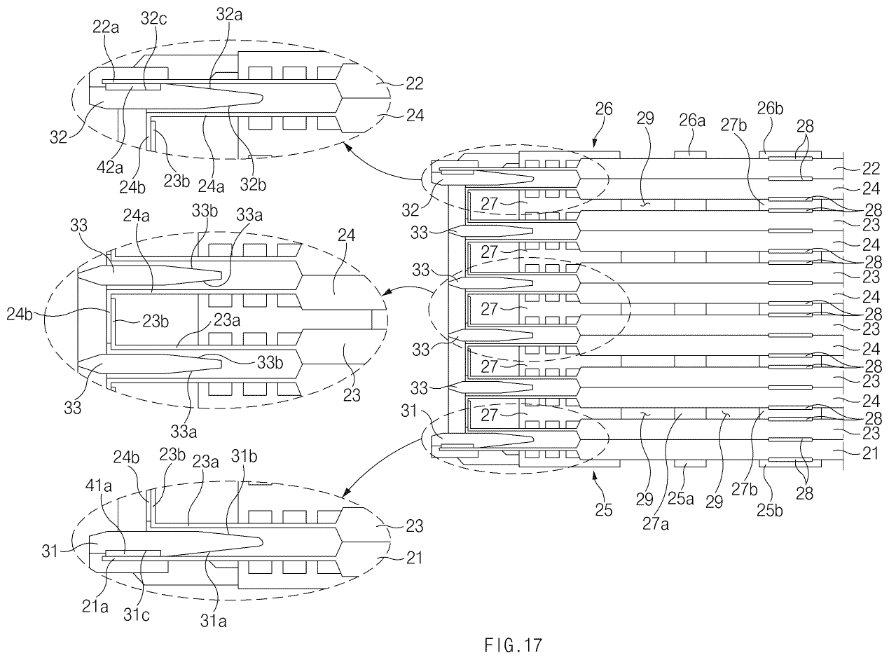

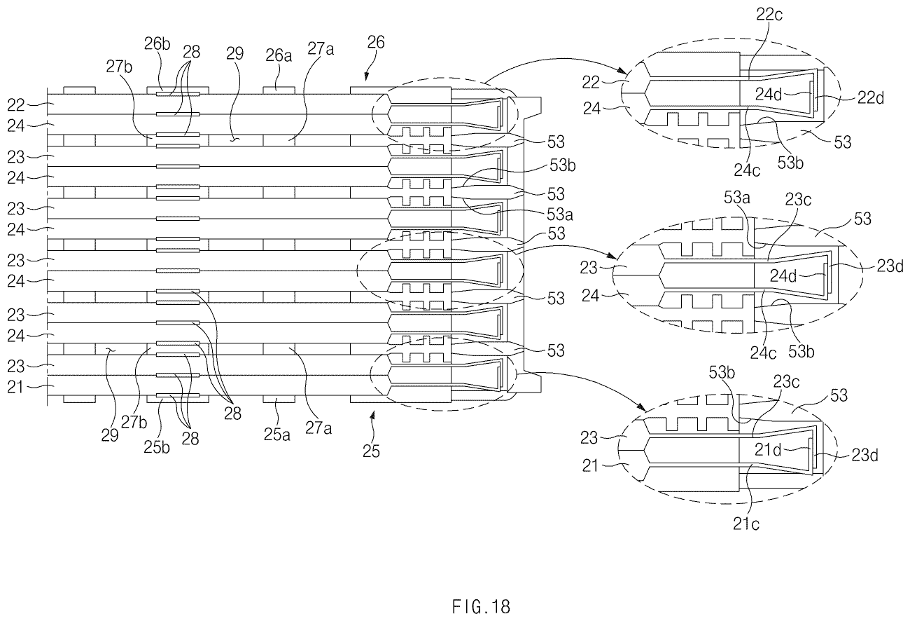

The first end battery cell 21 may have a front lead tab 21a extending from a front edge thereof and a rear lead tab 21c extending from a rear edge thereof. Referring to FIG. 17, the front lead tab 21a of the first end battery cell 21 may electrically contact a first contact 41a of a first bus bar 41. Referring to FIG. 18, the first end battery cell 21 may have a rear contact 21d bent from the rear lead tab 21c.

The second end battery cell 22 may have a front lead tab 22a extending from a front edge thereof and a rear lead tab 22c extending from a rear edge thereof. Referring to FIG. 17, the front lead tab 22a of the second end battery cell 22 may electrically contact a second contact 42a of a second bus bar 42. Referring to FIG. 18, the second end battery cell 22 may have a rear contact 22d bent from the rear lead tab 22c.

Each first middle battery cell 23 may have a front lead tab 23a extending from a front edge thereof and a rear lead tab 23c extending from a rear edge thereof. Referring to FIG. 17, the first middle battery cell 23 may have a front contact 23b bent from the front lead tab 23a. Referring to FIG. 18, the first middle battery cell 23 may have a rear contact 23d bent from the rear lead tab 23c.

Each second middle battery cell 24 may have a front lead tab 24a extending from a front edge thereof and a rear lead tab 24c extending from a rear edge thereof. Referring to FIG. 17, the second middle battery cell 24 may have a front contact 24b bent from the front lead tab 24a. Referring to FIG. 18, the second middle battery cell 24 may have a rear contact 24d bent from the rear lead tab 24c.

Referring to FIGS. 17 and 18, any one of the first middle battery cells 23 may be adjacent to or contact the first end battery cell 21 side by side. Referring to FIG. 18, the rear contact 23d of the first middle battery cell 23 contacting the first end battery cell 21 may be electrically connected to the rear contact 21d of the first end battery cell 21 by welding.

Referring to FIGS. 17 and 18, any one of the second middle battery cells 24 may be adjacent to or contact the second end battery cell 22 side by side. Referring to FIG. 18, the rear contact 24d of the second middle battery cell 24 contacting the second end battery cell 22 may be electrically connected to the rear contact 22d of the second end battery cell 22 by welding.

Referring to FIGS. 17 and 18, the first middle battery cells 23 and the second middle battery cells 24 may be alternately arranged. Referring to FIG. 17, the front contact 23b of the first middle battery cell 23 may be electrically connected to the front contact 24b of the second middle battery cell 24 adjacent thereto by welding. Referring to FIG. 18, the rear contact 23d of the first middle battery cell 23 may be electrically connected to the rear contact 24d of the second middle battery cell 24 adjacent thereto by welding.

Referring to FIGS. 16, 17, and 18, the number of electric connection structures between the front lead tabs 23a and 24a of the battery cells 23 and 24 may be five. The number of electric connection structures between the rear lead tabs 21c, 22c, 23c, and 24c of the battery cells 21, 22, 23, and 24 may be six. Specifically, the number of the above-mentioned elements may be as follows: the number of the battery cells 21, 22, 23, and 24 may be twelve. The number of the first end battery cell 21 may be one. The number of the second end battery cell 22 may be one. The number of the middle battery cells 23 and 24 may be ten. The number of the electric connection structures between the front lead tabs 23a of the first middle battery cells 23 and the front lead tabs 24a of the second middle battery cells 24 may be five. The number of the electric connection structure between the rear lead tab 21c of the first end battery cell 21 and the rear lead tab 23c of the first middle battery cell 23 may be one. The number of the electric connection structures between the rear lead tabs 23c of the first middle battery cells 23 and the rear lead tabs 24c of the second middle battery cells 24 may be four. The number of the electric connection structure between the rear lead tab 22c of the second end battery cell 22 and the rear lead tab 24c of the second middle battery cell 24 may be one.

Referring to FIGS. 16-18, a cooling passage 29 may be formed between the plurality of battery cells 21, 22, 23, and 24. As cold air passes through the cooling passage 29, the plurality of battery cells 21, 22, 23, and 24 may be properly cooled.

The plurality of frames 25, 26, and 27 may have a plurality of hooks 25c, 26c, and 27c and a plurality of locking portions 25d, 26d, and 27d provided on top and bottom edges thereof, respectively. The plurality of hooks 25c, 26c, and 27c may be snap-fitted into the plurality of corresponding locking portions 25d, 26d, and 27d so that the plurality of frames 25, 26, and 27 may be firmly connected to each other.

Referring to FIG. 16, the plurality of frames 25, 26, and 27 may include a first end frame 25 supporting the first end battery cell 21, a second end frame 26 supporting the second end battery cell 22, and a plurality of middle frames 27 supporting the plurality of middle battery cells 22 and 23.

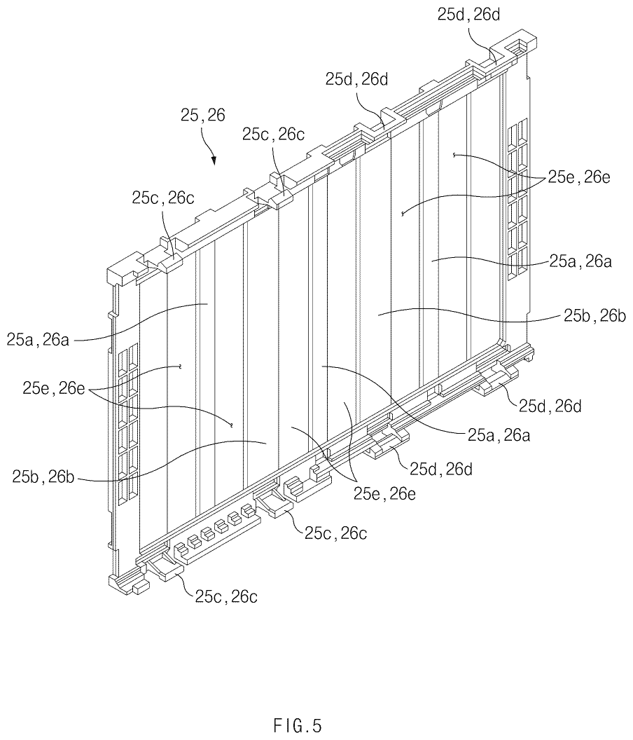

Referring to FIG. 5, the first end frame 25 may have a plurality of supports 25a and 25b extending from top to bottom. The plurality of supports 25a and 25b may contact the first end battery cell 21 to thereby support the first end battery cell 21. The plurality of supports 25a and 25b may be spaced apart from each other by a predetermined gap in a longitudinal direction of the first end frame 25 so that a plurality of openings 25e may be formed between the plurality of supports 25a and 25b. The plurality of supports 25a and 25b may include a plurality of first supports 25a spaced apart from each other by a predetermined gap. A plurality of second supports 25b arranged alternately with the plurality of first supports 25a. A width of the second support 25b may be greater than a width of the first support 25a.

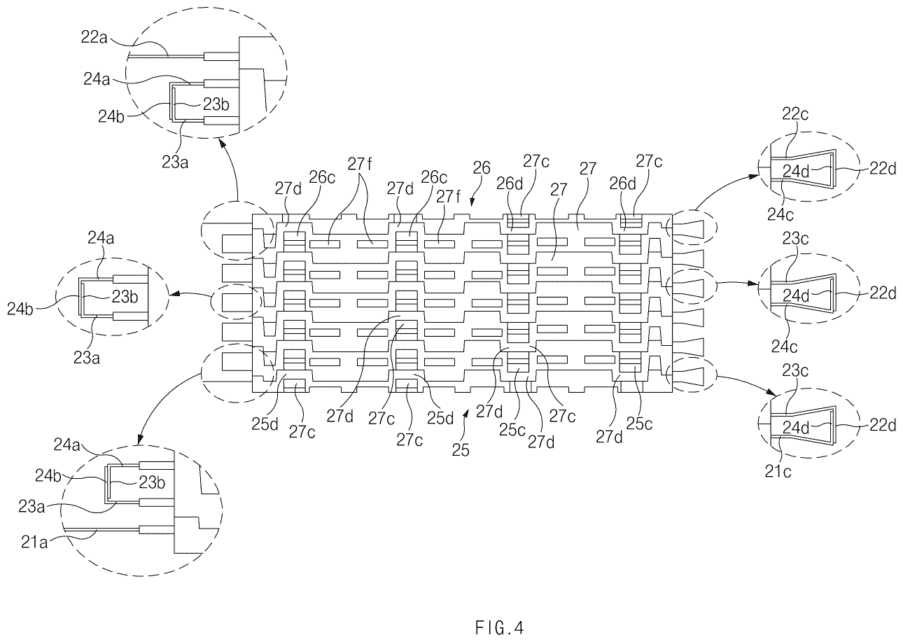

Referring to FIG. 5, the first end frame 25 may have a plurality of hooks 25c and a plurality of locking portions 25d provided on top and bottom edges thereof. The plurality of hooks 25c and the plurality of locking portions 25d may be arranged to be symmetrical to each other on the top and bottom edges of the first end frame 25. For example, the first end frame 25 may have two hooks 25c and two locking portions 25d arranged symmetrically. Each hook 25c may be provided on an end of a snap fit arm having a cantilever structure extending from the first end frame 25. The snap fit arm may be elastically deformed and each locking portion 25d may have a slot. Referring to FIG. 4, the hook 25c of the first end frame 25 and a slot of a corresponding locking portion 27d of the adjacent middle frame 27 may be snap-fitted. The slot of the locking portion 25d of the first end frame 25 and a corresponding hook 27c of the adjacent middle frame 27 may be snap-fitted. The plurality of hooks 25c and the plurality of locking portions 25d provided on the top edge of the first end frame 25 may be flush with a top surface of the first end frame 25. Thus, the plurality of hooks 25c and the plurality of locking portions 25d may not protrude upward from the top surface of the first end frame 25. Accordingly, the top surface of the first end frame 25 may maintain a flat state. The plurality of hooks 25c and the plurality of locking portions 25d provided on the bottom edge of the first end frame 25 may be flush with a bottom surface of the first end frame 25. Thus, the plurality of hooks 25c and the plurality of locking portions 25d may not protrude downward from the bottom surface of the first end frame 25. Accordingly, the bottom surface of the first end frame 25 may maintain a flat state.

Referring to FIG. 5, the second end frame 26 may have a plurality of supports 26a and 26b extending from top to bottom. The plurality of supports 26a and 26b may contact the second end battery cell 22 to thereby support the second end battery cell 22. The plurality of supports 26a and 26b may be spaced apart from each other by a predetermined gap in a longitudinal direction of the second end frame 26 so that a plurality of openings 26e may be formed between the plurality of supports 26a and 26b. The plurality of supports 26a and 26b may include a plurality of first supports 26a spaced apart from each other by a predetermined gap and a plurality of second supports 26b arranged alternately with the plurality of first supports 26a. A width of the second support 26b may be greater than a width of the first support 26a.

Referring to FIG. 5, the second end frame 26 may have a plurality of hooks 26c and a plurality of locking portion 26d provided on top and bottom edges thereof. The plurality of hooks 26c and the plurality of locking portion 26d may be arranged to be symmetrical to each other on the top and bottom edges of the second end frame 26. For example, the second end frame 26 may have two hooks 26c and two locking portions 26d arranged symmetrically. Referring to FIG. 4, each hook 26c may be provided on an end of a snap fit arm having a cantilever structure extending from the second end frame 26. The snap fit arm may be elastically deformed and each locking portion 26d may have a slot. The hook 26c of the second end frame 26 and a slot of a corresponding locking portion 27d of the adjacent middle frame 27 may be snap-fitted. The slot of the locking portion 26d of the second end frame 26 and a corresponding hook 27c of the adjacent middle frame 27 may be snap-fitted. The plurality of hooks 26c and the plurality of locking portions 26d provided on the top edge of the second end frame 26 may be flush with a top surface of the second end frame 26. Thus, the plurality of hooks 26c and the plurality of locking portions 26d may not protrude upward from the top surface of the second end frame 26. Accordingly, the top surface of the second end frame 26 may maintain a flat state. The plurality of hooks 26c and the plurality of locking portions 26d provided on the bottom edge of the second end frame 26 may be flush with a bottom surface of the second end frame 26. Thus, the plurality of hooks 26c and the plurality of locking portions 26d may not protrude downward from the bottom surface of the second end frame 26. Accordingly, the bottom surface of the second end frame 26 may maintain a flat state.

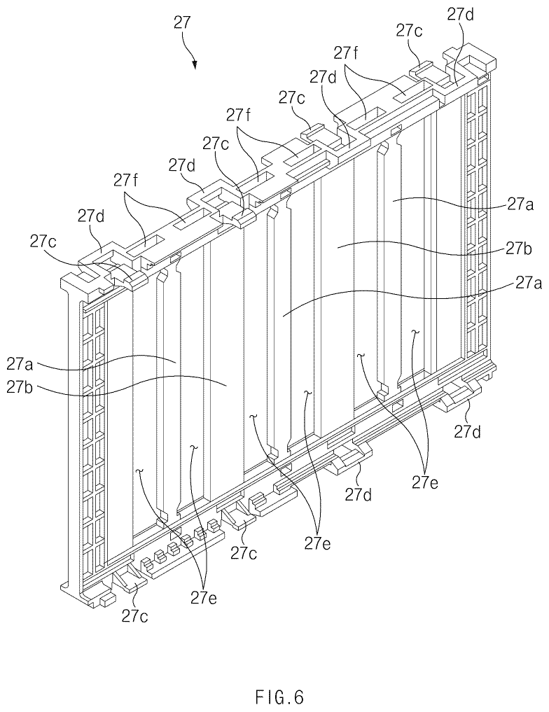

Referring to FIG. 6, each middle frame 27 may have a plurality of supports 27a and 27b extending from top to bottom. The plurality of supports 27a and 27b may contact the corresponding one of the middle battery cells 23 and 24. The plurality of supports 27a and 27b may be spaced apart from each other by a predetermined gap in a longitudinal direction of the middle frame 27. Thus, a plurality of openings 27e may be formed between the plurality of supports 27a and 27b. The plurality of supports 27a and 27b may include a plurality of first supports 27a spaced apart from each other by a predetermined gap and a plurality of second supports 27b arranged alternately with the plurality of first supports 27a. A width of the second support 27b may be greater than a width of the first support 27a.

Referring to FIG. 6, each middle frame 27 may have a plurality of hooks 27c and a plurality of locking portions 27d provided on top and bottom edges thereof. The plurality of hooks 27c and the plurality of locking portions 27d may be arranged to be symmetrical to each other on the top and bottom edges of the middle frame 27. The hooks 27c and the locking portions 27d may be arranged on the top and bottom edges of the middle frame 27 in a width direction of the middle frame 27. Specifically, the hooks 27c and the locking portions 27d may be arranged symmetrically in the width direction of the middle frame 27. Each hook 27c may be provided on an end of a snap fit arm having a cantilever structure extending from the middle frame 27. The snap fit arm may be elastically deformed and each locking portion 27d may have a slot. Referring to FIG. 4, the hook 27c of any one middle frame 27 and the slot of the corresponding locking portion 27d of another adjacent middle frame 27 may be snap-fitted. The slot of the locking portion 27d of any one middle frame 27 and the corresponding hook 27c of another adjacent middle frame 27 may be snap-fitted. In addition, the hook 27c of the middle frame 27 adjacent to the first end frame 25 may be snap-fitted into the slot of the corresponding locking portion 25d of the first end frame 25. The hook 25c of the first end frame 25 may be snap-fitted into the slot of the corresponding locking portion 27d of the middle frame 27 adjacent thereto. The hook 27c of the middle frame 27 adjacent to the second end frame 26 may be snap-fitted into the slot of the corresponding locking portion 26d of the second end frame 26. The hook 26c of the second end frame 26 may be snap-fitted into the slot of the corresponding locking portion 27d of the middle frame 27 adjacent thereto.

Referring to FIG. 6, the plurality of hooks 27c and the plurality of locking portions 27d provided on the top edge of the middle frame 27 may be flush with a top surface of the middle frame 27. Thus, the plurality of hooks 27c and the plurality of locking portions 27d may not protrude upward from the top surface of the middle frame 27. Accordingly, the top surface of the middle frame 27 may maintain a flat state. The plurality of hooks 27c and the plurality of locking portions 27d provided on the bottom edge of the middle frame 27 may be flush with a bottom surface of the middle frame 27. Thus, the plurality of hooks 27c and the plurality of locking portions 27d may not protrude downward from the bottom surface of the middle frame 27. Accordingly, the bottom surface of the middle frame 27 may maintain a flat state.

The middle frame 27 may have a plurality of through holes 27f formed in the top and bottom portions thereof and the plurality of through holes 27f may be aligned with the cooling passage 29 between the battery cells 21, 22, 23, and 24. As the cold air passes through the through holes 27f of the middle frames 27 and the cooling passage 29, the battery cells 21, 22, 23, and 24 may be properly cooled.

According to the related art, each battery cell may be positioned and retained in a frame by positioning projections provided on the frame. However, since the positioning projections are integrally formed with and fixed to the frame, the size and structure of the battery cell may only be specified to the corresponding frame. Accordingly, the existing frame may only support the battery cell having particular specifications (size, structure, etc.), so it cannot support a variety of battery cells having various specifications.

According to an embodiment of the present disclosure, the battery cells 21, 22, 23, and 24 may be positioned with respect to the corresponding frames 25, 26, and 27 by various guide mechanisms or jig mechanisms. The battery cells 21, 22, 23, and 24 may be fixed to the corresponding frames 25, 26, and 27 by adhesive layers 28 such as hot melt so that the battery cells 21, 22, 23, and 24 may remain positioned in the corresponding frames 25, 26, and 27.

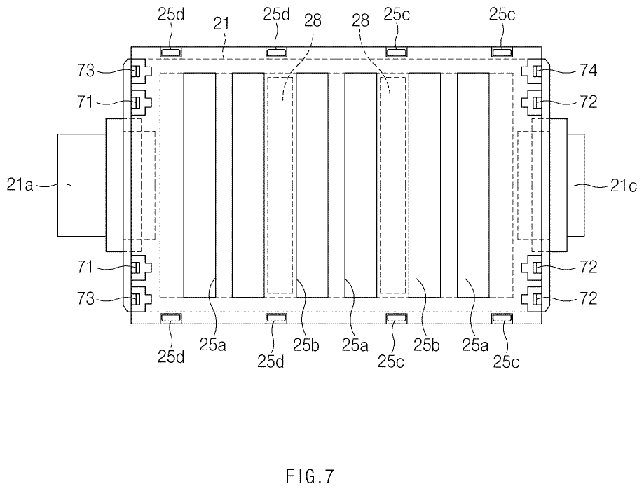

The first end battery cell 21 may be positioned in the first end frame 25 by various guide mechanisms or jig mechanisms. The first end battery cell 21 may be fixed to the first end frame 25 by the adhesive layers 28 such as hot melt so that the first end battery cell 21 may remain positioned in the first end frame 25. Referring to FIG. 7, the adhesive layers 28 may be applied to the second supports 25b of the first end frame 25. The first end battery cell 21 may be fixed to the second supports 25b of the first end frame 25.

The second end battery cell 22 may be positioned in the second end frame 26 by various guide mechanisms or jig mechanisms. The second end battery cell 22 may be fixed to the second end frame 26 by the adhesive layers 28 such as hot melt so that the second end battery cell 22 may remain positioned in the second end frame 26. Referring to FIGS. 16-18, the second end battery cell 22 may be fixed to the second supports 26b of the second end frame 26 by the adhesive layers 28 so that the second end battery cell 22 may remain positioned in the second end frame 26.

The middle battery cells 23 and 24 may be positioned in the corresponding middle frames 27 by various guide mechanisms or jig mechanisms. The middle battery cells 23 and 24 may be fixed to the corresponding middle frames 27 by the adhesive layers 28 such as hot melt so that the middle battery cells 23 and 24 may remain positioned in the corresponding middle frames 27. Referring to FIGS. 16-18, the middle battery cells 23 and 24 may be fixed to the second supports 27b of the corresponding middle frames 27 by the adhesive layers 28 so that the middle battery cells 23 and 24 may remain positioned in the corresponding middle frames 27.

Referring to FIGS. 16 and 18, the battery cells 21, 22, 23, and 24 contacting each other may be fixed to each other by the adhesive layers 28.

As described above, the battery cells 21, 22, 23, and 24 may be fixed to the corresponding frames 25, 26, and 27 by the adhesive layers 28 such as hot melt. The contacting battery cells 21, 22, 23, and 24 may be fixed to each other by the adhesive layers 28 so that the plurality of battery cells 21, 22, 23, and 24 may stably remain positioned between the plurality of frames 25, 26, and 27.

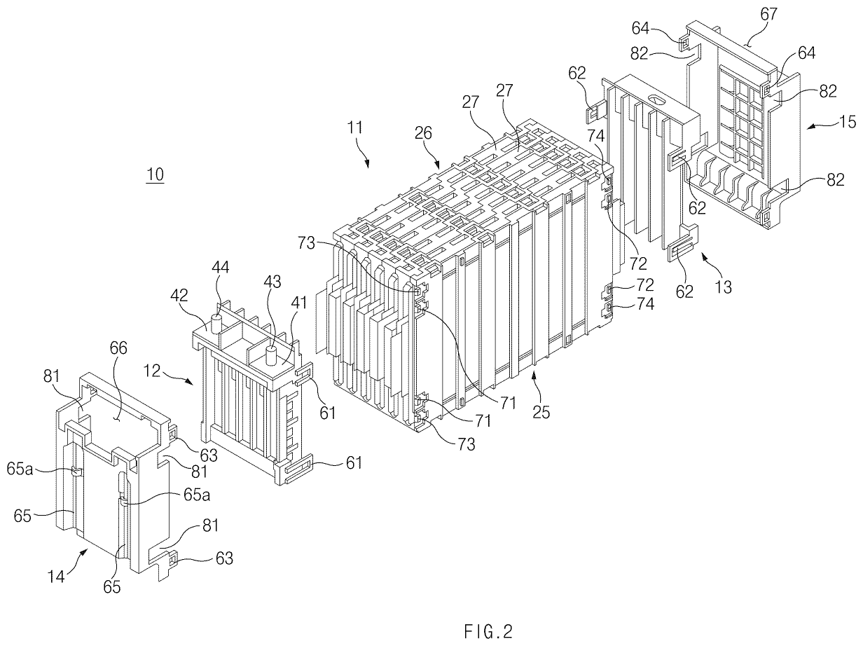

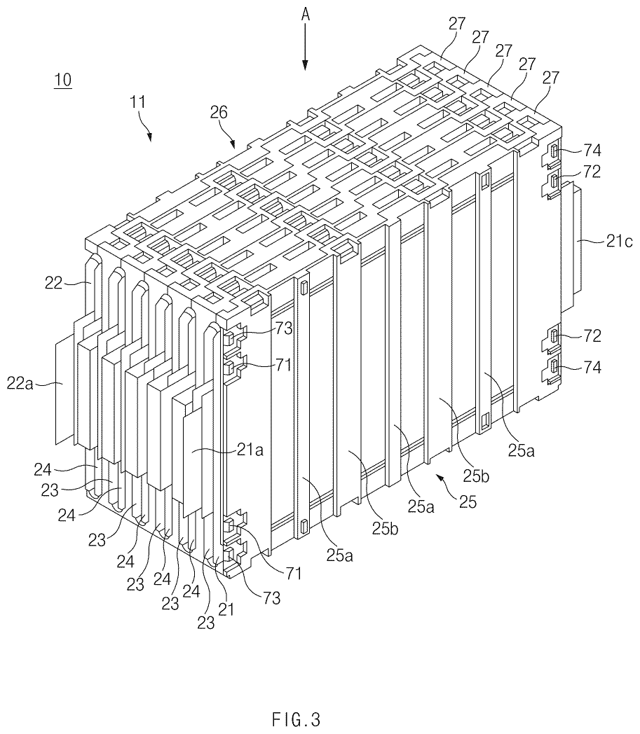

Referring to FIGS. 2 and 3, the first end frame 25 may have a plurality of front hooks 71 and 73 provided on a front portion thereof. Likewise, the second end frame 26 may have a plurality of front hooks (not shown) provided on a front portion thereof. The first end frame 25 may have a plurality of rear hooks 72 and 74 provided on a rear portion thereof. Likewise, the second end frame 26 may have a plurality of rear hooks (not shown) provided on a rear portion thereof.

Referring to FIG. 2, the front sensing assembly 12 may measure voltages of the plurality of battery cells 21, 22, 23, and 24. The front sensing assembly 12 may have a plurality of front snap fit locks 61 extending toward the front of the battery cell assembly 11. The plurality of front snap fit locks 61 may be provided on both left and right sides of the battery cell assembly 11. The plurality of front snap fit locks 61 may be snap-fitted to the front hooks 71 of the first end frame 25 of the battery cell assembly 11 and the front hooks (not shown) of the second end frame 26 of the battery cell assembly 11. Accordingly, the front sensing assembly 12 may fully cover the front end of the battery cell assembly 11.

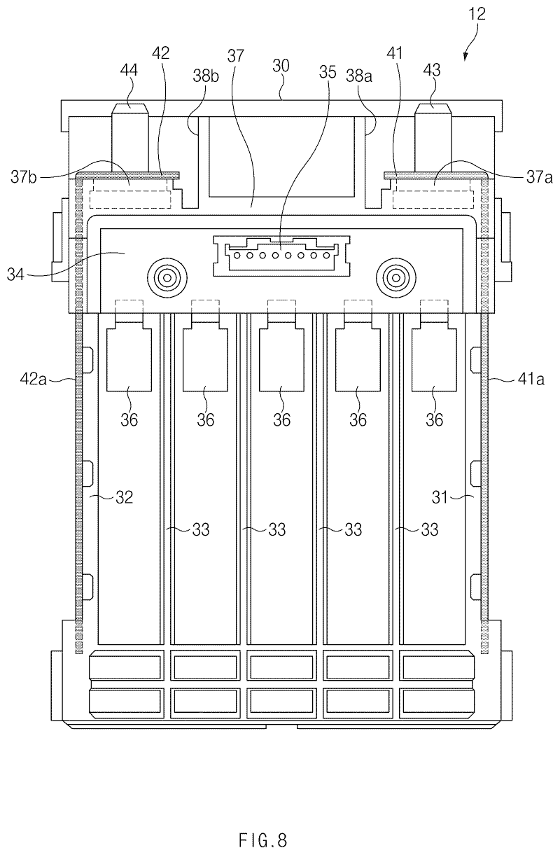

Referring to FIG. 8, the front sensing assembly 12 may include a front sensing body 30, a front sensing printed circuit board (PCB) 34 mounted on the front sensing body 30, a front connector 35 disposed on a central portion of the front sensing PCB 34, and a plurality of front sensing bus bars 36 electrically connected to the front sensing PCB 34 and the plurality of battery cells 21, 22, 23, and 24.

The front sensing body 30 may be made of an insulating material and the front sensing PCB 34 may be fixed to an upper portion of the front sensing body 30 through fusion. The front connector 35 may be electrically connected to the front sensing PCB 34. A plug (not shown) of a voltage sensing wire may be inserted into the front connector 35. The plurality of front snap fit locks 61 may extend from both sides of the front sensing body 30 toward the battery cell assembly 11.

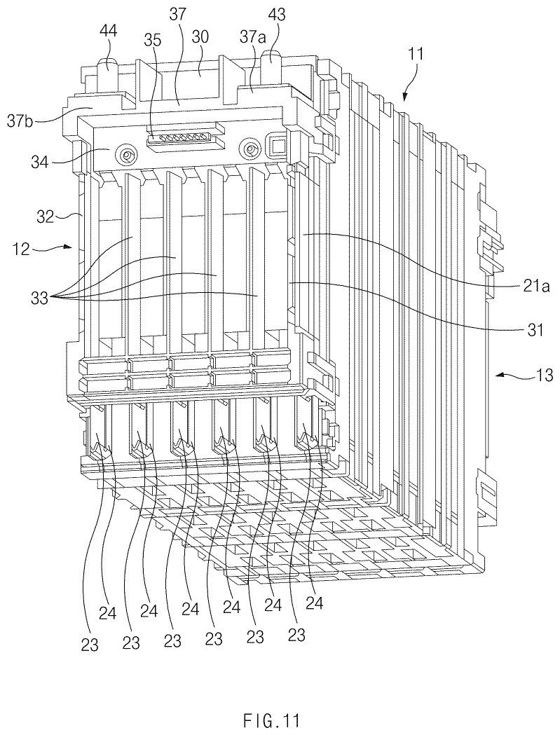

The front sensing body 30 may include a front roof portion 37 located above the front sensing PCB 34. The front roof portion 37 may protrude forward from the front sensing body 30. Referring to FIG. 11, the front roof portion 37 may fully cover a top surface of the front connector 35. Accordingly, the front roof portion 37 may prevent moisture and other foreign objects from entering the front connector 35.

Referring to FIG. 8, the front sensing assembly 12 may include a first terminal block 37a and a second terminal block 37b provided on both left and right sides of the front roof portion 37, a first terminal 43 fixed to the first terminal block 37a, and a second terminal 44 fixed to the second terminal block 37b. A lower portion of the first terminal 43 may be embedded in the first terminal block 37a and a lower portion of the second terminal 44 may be embedded in the second terminal block 37b. The first bus bar 41 may be electrically connected to the first terminal 43 by welding and the second bus bar 42 may be electrically connected to the second terminal 44 by welding.

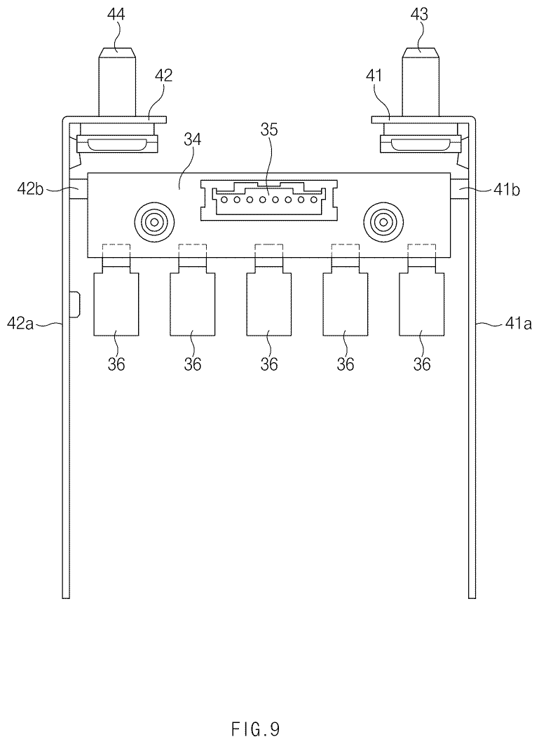

Referring to FIG. 9, the first bus bar 41 may be electrically connected to the front sensing PCB 34 through a conductive portion 41b. The second bus bar 42 may be electrically connected to the front sensing PCB 34 through a conductive portion 42b. For example, the first bus bar 41 may be a positive (+) electrode, and the second bus bar 42 may be a negative (−) electrode.

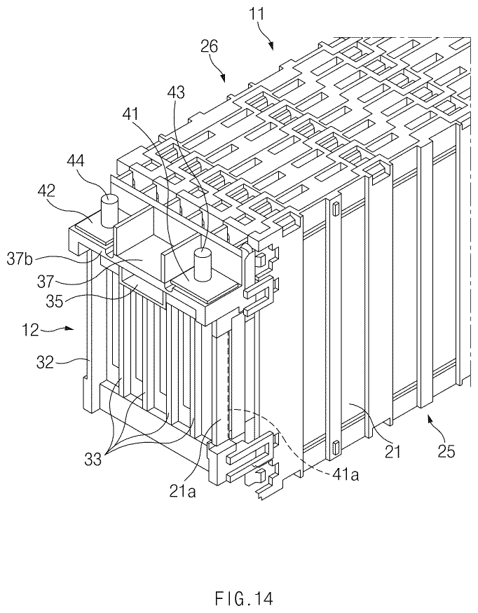

Referring to FIG. 9, the first bus bar 41 may have the first contact 41a bent downward from one edge thereof. Referring to FIG. 8, an upper portion of the first contact 41a may be embedded in the first terminal block 37a and a lower portion of the first contact 41a may be exposed. Referring to FIGS. 14 and 17, the first contact 41a may contact the front lead tab 21a of the first end battery cell 21. The first contact 41a may be electrically connected to the front lead tab 21a of the first end battery cell 21 by welding.

Referring to FIG. 9, the second bus bar 42 may have the second contact 42a bent downward from one edge thereof. Referring to FIG. 8, an upper portion of the second contact 42a may be embedded in the second terminal block 37b and a lower portion of the second contact 42a may be exposed. Referring to FIG. 17, the second contact 42a may contact the front lead tab 22a of the second end battery cell 22. The second contact 42a may be electrically connected to the front lead tab 22a of the second end battery cell 22 by welding.

The plurality of front sensing bus bars 36 may be electrically connected to the contacts 23b and 24b of the front lead tabs 23a and 24a of the middle battery cells 23 and 24 by welding. Specifically, each front sensing bus bar 36 may be connected to an electric connection structure between the front lead tabs 23a and 24a of the corresponding middle battery cells 23 and 24 by welding. For example, the number of the electric connection structures between the front lead tabs 23a and 24a of the middle battery cells 23 and 24 may be five and the number of the corresponding front sensing bus bars 36 may be five.

The front sensing body 30 may include a first end guide rib 31 supporting the first contact 41a of the first bus bar 41, a second end guide rib 32 supporting the second contact 42a of the second bus bar 42, and a plurality of middle guide ribs 33 disposed between the first end guide rib 31 and the second end guide rib 32.

Referring to FIG. 8, the first end guide rib 31, the second end guide rib 32, and the plurality of middle guide ribs 33 may extend vertically from the upper portion of the front sensing body 30 to the lower portion of the front sensing body 30. The first end guide rib 31, the second end guide rib 32, and the plurality of middle guide ribs 33 may be spaced apart from each other in a width direction of the front sensing body 30. The plurality of front sensing bus bars 36 may be located between the guide ribs 31, 32, and 33.

The first end guide rib 31, the second end guide rib 32, and the plurality of middle guide ribs 33 may prevent the non-electrically connected front lead tabs 21a, 22a, 23a, and 24a from contacting each other due to deformation or the like caused by external impacts during an assembly process. A short circuit is thereby prevented between the battery cells 21, 22, 23, and 24.

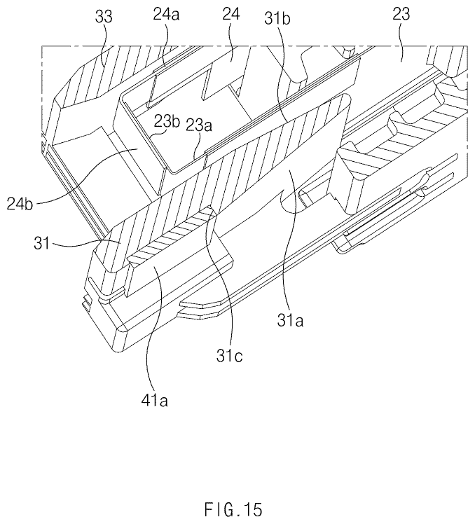

Referring to FIGS. 15 and 17, the first end guide rib 31 may have a recessed portion 31c in which the lower portion of the first contact 41a of the first bus bar 41 is received. As the lower portion of the first contact 41a of the first bus bar 41 is received in the recessed portion 31c of the first end guide rib 31, the first end guide rib 31 may stably support the first contact 41a of the first bus bar 41. Referring to FIG. 17, the first end guide rib 31 may have a pair of guide surfaces 31a and 31b inclined to guide the front lead tabs 21a and 23a of the battery cells 21 and 23. One guide surface 31a may be inclined from the recessed portion 31c at a predetermined angle. Accordingly, one guide surface 31a may guide the front lead tab 21a of the first end battery cell 21 to the first contact 41a of the first bus bar 41. The other guide surface 31b may be inclined to guide the front lead tab 23a of the first middle battery cell 23 adjacent to the first end battery cell 21.

Referring to FIG. 17, the second end guide rib 32 may have a recessed portion 32c in which the lower portion of the second contact 42a of the second bus bar 42 is received. As the lower portion of the second contact 42a of the second bus bar 42 is received in the recessed portion 32c of the second end guide rib 32, the second end guide rib 32 may stably support the second contact 42a of the second bus bar 42. Referring to FIG. 17, the second end guide rib 32 may have a pair of guide surfaces 32a and 32b inclined to guide the front lead tabs 22a and 24a of the battery cells 22 and 24. One guide surface 32a may be inclined from the recessed portion 32c at a predetermined angle. Accordingly, one guide surface 32a may guide the front lead tab 22a of the second end battery cell 22 to the second contact 42a of the second bus bar 42. The other guide surface 32b may be inclined to guide the front lead tab 24a of the second middle battery cell 24 adjacent to the second end battery cell 22.

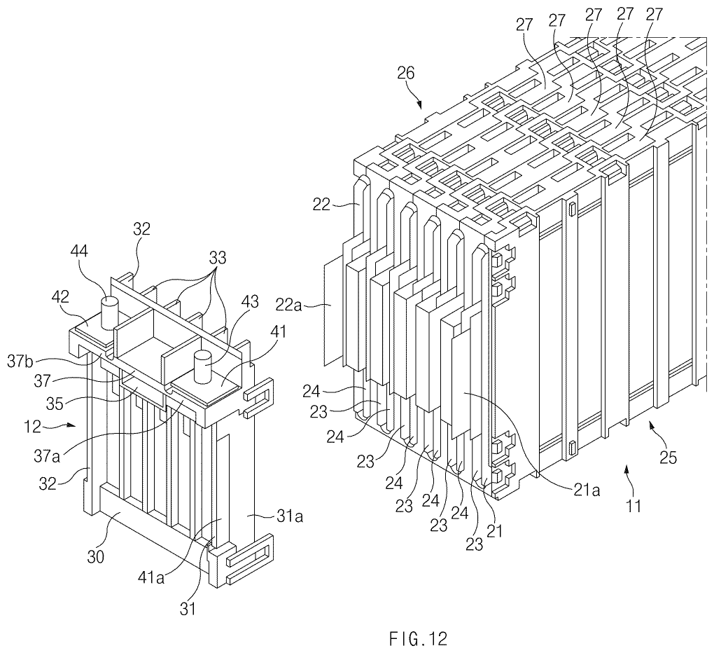

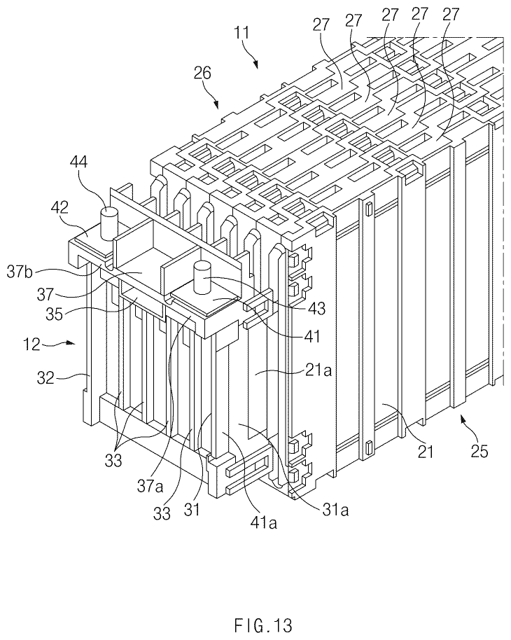

FIG. 12 illustrates a state before the front sensing assembly 12 is mounted on the front end of the battery cell assembly 11. Referring to FIG. 13, when the front sensing assembly 12 comes close to the front end of the battery cell assembly 11, the front lead tab 21a of the first end battery cell 21 may be guided along one guide surface 31a of the first end guide rib 31. Referring to FIGS. 14 and 17, the front lead tab 21a of the first end battery cell 21 may be guided by one guide surface 31a of the first end guide rib 31 to directly contact the first contact 41a of the first bus bar 41. Likewise, the front lead tab 22a of the second end battery cell 22 may be guided by one guide surface 32a of the second end guide rib 32 to directly contact the second contact 42a of the second bus bar 42.

Referring to FIG. 17, the middle guide rib 33 may have a pair of guide surfaces 33a and 33b inclined to guide the front lead tab 23a of the first middle battery cell 23 and the front lead tab 24a of the second middle battery cell 24.

Referring to FIG. 2, the rear sensing assembly 13 may measure voltages of the plurality of battery cells 21, 22, 23, and 24. The rear sensing assembly 13 may have a plurality of rear snap fit locks 62 extending toward the rear of the battery cell assembly 11. The plurality of rear snap fit locks 62 may be provided on both left and right sides of the rear sensing assembly 13. The plurality of rear snap fit locks 62 may be snap-fitted to the rear hooks 72 of the first end frame 25 of the battery cell assembly 11 and the rear hooks (not shown) of the second end frame 26 of the battery cell assembly 11. Accordingly, the rear sensing assembly 13 may fully cover the rear end of the battery cell assembly 11.

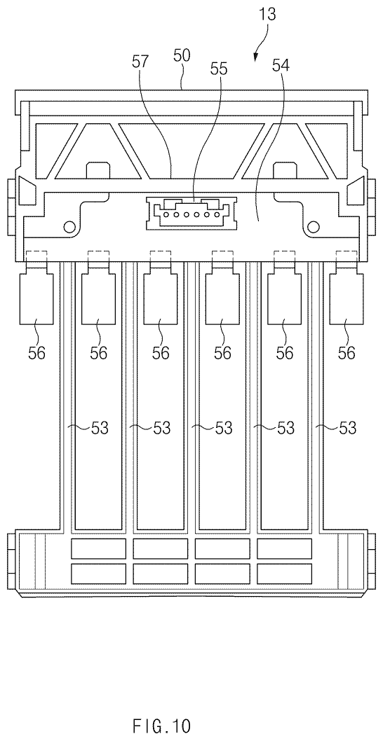

Referring to FIG. 10, the rear sensing assembly 13 may include a rear sensing body 50, a rear sensing PCB 54 mounted on the rear sensing body 50, a rear connector 55 disposed on a central portion of the rear sensing PCB 54. The rear sensing assembly 13 may also include a plurality of rear sensing bus bars 56 electrically connected to the rear sensing PCB 54 and the plurality of battery cells 21, 22, 23, and 24.

The rear sensing body 50 may be made of an insulating material and the rear sensing PCB 54 may be fixed to an upper portion of the rear sensing body 50 through fusion. The rear connector 55 may be electrically connected to the rear sensing PCB 54. A plug (not shown) of a voltage sensing wire may be inserted into the rear connector 55. The plurality of rear snap fit locks 62 may extend from both sides of the rear sensing body 50 toward the battery cell assembly 11.

The rear sensing body 50 may include a rear roof portion 57 located above the rear sensing PCB 54. The rear roof portion 57 may protrude rearward from the rear sensing body 50. Referring to FIG. 10, the rear roof portion 57 may fully cover a top surface of the rear connector 55. Accordingly, the rear roof portion 57 may prevent moisture and other foreign objects from entering the rear connector 55.

The plurality of rear sensing bus bars 56 may be electrically connected to the contacts 21d, 22d, 23d, and 24d of the rear lead tabs 21c, 22c, 23c, and 24c of the battery cells 21, 22, 23, and 24 by welding. Specifically, the rear sensing bus bars 56 may be connected to electric connection structures between the rear lead tabs 21c, 22c, 23c, and 24c of the corresponding battery cells 21, 22, 23, and 24 by welding. For example, the number of the electric connection structures between the rear lead tabs 21c, 22c, 23c, and 24c of the battery cells 21, 22, 23, and 24 may be six and the number of the corresponding rear sensing bus bars 56 may be six.

Referring to FIG. 18, the rear sensing body 50 may have a plurality of guide ribs 53 guiding the rear lead tabs 21c, 22c, 23c, and 24c of the battery cells 21, 22, 23, and 24.

Referring to FIG. 10, the plurality of guide ribs 53 may extend vertically from the upper portion of the rear sensing body 50 to the lower portion of the rear sensing body 50. The plurality of guide ribs 53 may be spaced apart from each other in a width direction of the rear sensing body 50 and the plurality of rear sensing bus bars 56 may be located between the guide ribs 53. The plurality of guide ribs 53 may prevent the non-electrically connected rear lead tabs 21c, 22c, 23c, and 24c from contacting each other due to deformation or the like caused by external impacts during an assembly process. A short circuit is thereby prevented between the battery cells 21, 22, 23, and 24.

Referring to FIG. 18, the plurality of guide ribs 53 may have a plurality of guide surfaces 53a and 53b inclined to guide the rear lead tabs 21c, 22c, 23c, and 24c of the battery cells 21, 22, 23, and 24.

Referring to FIG. 2, the front cover 14 may be coupled to the front end of the battery cell assembly 11 to cover at least a portion of the front sensing assembly 12. The front cover 14 may have a plurality of front snap fit locks 63 extending toward the front of the battery cell assembly 11. The plurality of front snap fit locks 63 may be provided on both sides of the front cover 14. The plurality of front snap fit locks 63 may be snap-fitted to the front hooks 73 of the first end frame 25 of the battery cell assembly 11 and the front hooks (not shown) of the second end frame 26 of the battery cell assembly 11. Accordingly, the front cover 14 may cover the front sensing assembly 12.

The front cover 14 may have a front opening 66 matching the upper portion of the front sensing assembly 12. The front opening 66 may be shaped to match the first bus bar 41, the second bus bar 42, the first terminal 43, the second terminal 44, and the front connector 35 located on the upper portion of the front sensing assembly 12. In a state in which the front cover 14 covers the front sensing assembly 12, the first bus bar 41, the second bus bar 42, the first terminal 43, the second terminal 44, and the front connector 35 may be exposed through the front opening 66.

The front cover 14 may have a groove 65 receiving the voltage sensing wire connected to the front connector 35 of the front sensing assembly 12. The groove 65 may extend along a height direction of the front cover 14. A holding rib 65a may be provided to cover at least a portion of the groove 65. Accordingly, the holding rib 65 may hold the voltage sensing wire received in the groove 65.

In addition, the front cover 14 may have a plurality of openings 81 receiving the snap fit locks 61 of the front sensing assembly 12. When the front cover 14 covers the front sensing assembly 12, the snap fit locks 61 of the front sensing assembly 12 may be received in the corresponding openings 81 of the front cover 14 so that the front cover 14 may tightly cover the front sensing assembly 12.

The rear cover 15 may be coupled to the rear end of the battery cell assembly 11 to cover at least a portion of the rear sensing assembly 13. The rear cover 15 may have a plurality of rear snap fit locks 64 extending toward the rear of the battery cell assembly 11 and the plurality of rear snap fit locks 64 may be provided on both sides of the rear cover 15. The plurality of rear snap fit locks 64 may be snap-fitted to the rear hooks 74 of the first end frame 25 of the battery cell assembly 11 and the rear hooks (not shown) of the second end frame 26 of the battery cell assembly 11. Accordingly, the rear cover 15 may cover the rear sensing assembly 13.

The rear cover 15 may have a rear opening 67 matching the upper portion of the rear sensing assembly 13. In a state in which the rear cover 15 covers the rear sensing assembly 13, the rear connector 55 may be exposed through the rear opening 67.

Like the front cover 14, the rear cover 15 may have a groove (not shown) receiving the voltage sensing wire connected to the rear connector 55 of the rear sensing assembly 13. The groove may extend along a height direction of the rear cover 15. A holding rib (not shown) may be provided to cover at least a portion of the groove. Accordingly, the holding rib may hold the voltage sensing wire received in the groove.

In addition, the rear cover 15 may have a plurality of openings 82 receiving the snap fit locks 62 of the rear sensing assembly 13. When the rear cover 15 covers the rear sensing assembly 13, the snap fit locks 62 of the rear sensing assembly 13 may be received in the corresponding openings 82 of the rear cover 15 so that the rear cover 15 may tightly cover the rear sensing assembly 13.

As set forth above, the battery module according to various embodiments of the present disclosure may be designed to improve assemblability and productivity thereof and improve accuracy in sensing the voltages of the battery cells.

According to various embodiments of the present disclosure, each battery cell may be fixed to the corresponding frame by the adhesive layer such as hot melt so that the battery cell may be positioned in the corresponding frame. Accordingly, the battery cells having various specifications (size, shape, etc.) may be assembled in various manners.

According to various embodiments of the present disclosure, the front sensing assembly may be mounted on the front end of the battery cell assembly and the rear sensing assembly may be mounted on the rear end of the battery cell assembly so that the sensing wire may not be provided within the battery module. Thus, voltage sensing accuracy (accuracy in sensing the voltages of the battery cells) may be significantly improved.

According to various embodiments of the present disclosure, the front cover and the front sensing assembly may be snap-fitted onto the front end of the battery cell assembly. The rear cover and the rear sensing assembly may be snap-fitted onto the rear end of the battery cell assembly so that the assemblability and productivity of the battery module may be significantly improved.

Hereinabove, although the present disclosure has been described with reference to various embodiments and the accompanying drawings, the present disclosure is not limited thereto. The disclosed embodiments may be variously modified and altered by those of ordinary skill in the art to which the present disclosure pertains without departing from the spirit and scope of the present disclosure claimed in the following claims.

What is claimed is:

1. A battery module, comprising:
a battery cell assembly including a plurality of battery cells stacked therein and a plurality of frames supporting the plurality of battery cells;
a front sensing assembly measuring voltages of the plurality of battery cells and mounted on a front end of the battery cell assembly;
a rear sensing assembly measuring voltages of the plurality of battery cells and mounted on a rear end of the battery cell assembly;
a front cover covering at least a portion of the front sensing assembly; and
a rear cover covering at least a portion of the rear sensing assembly.

2. The battery module according to claim 1, wherein:
the plurality of battery cells includes a first end battery cell, a second end battery cell located opposite the first end battery cell, and a plurality of middle battery cells stacked between the first end battery cell and the second end battery cell; and
the plurality of frames includes a first end frame supporting the first end battery cell, a second end frame supporting the second end battery cell, and a plurality of middle frames supporting the plurality of middle battery cells.

3. The battery module according to claim 2, wherein:
the first end frame has a first plurality of supports supporting the first end battery cell;
the supports of the first plurality of supports are spaced apart from each other by a predetermined gap in a longitudinal direction of the first end frame; and
the first end battery cell is fixed to the first end frame by an adhesive layer applied to at least one support of the plurality of supports.

4. The battery module according to claim 2, wherein:
the second end frame has a plurality of second supports supporting the second end battery cell;
the supports of the second plurality of supports are spaced apart from each other by a predetermined gap in a longitudinal direction of the second end frame; and
the second end battery cell is fixed to the second end frame by an adhesive layer applied to at least one of the plurality of supports.

5. The battery module according to claim 2, wherein:
the middle frame has a plurality of middle supports supporting the middle battery cell;
the supports of the plurality of middle supports are spaced apart from each other by a predetermined gap in a longitudinal direction of the middle frame; and
the middle battery cell is fixed to the middle frame by an adhesive layer applied to at least one of the plurality of supports.

6. The battery module according to claim 1, wherein:
the front sensing assembly has a plurality of snap fit locks extending toward the front of the battery cell assembly; and
the snap fit locks of the plurality of snap fit locks are snap-fitted to front hooks provided on the front of the battery cell assembly, respectively.

7. The battery module according to claim 2, wherein the front sensing assembly includes:
a front sensing body;
a front sensing printed circuit board (PCB) mounted on the front sensing body;
a front connector disposed on a central portion of the front sensing PCB; and
a plurality of front sensing bus bars electrically connected to the front sensing PCB and the plurality of battery cells.

8. The battery module according to claim 7, wherein the front sensing body includes a front roof portion located above the front sensing PCB, and wherein the front roof portion fully covers a top surface of the front connector.

9. The battery module according to claim 8, wherein the front sensing assembly further includes:
a first terminal block and a second terminal block provided on both left and right sides of the front roof portion;
a first terminal fixed to the first terminal block;
a second terminal fixed to the second terminal block;
a first bus bar electrically connected to the first terminal; and
a second bus bar electrically connected to the second terminal,
wherein the first bus bar and the second bus bar are electrically connected to the plurality of battery cells.

10. The battery module according to claim 9, wherein:
the first bus bar has a first contact bent downward from one edge thereof;
an upper portion of the first contact is embedded in the first terminal block; and
the first contact is electrically connected to a front lead tab of the first end battery cell.

11. The battery module according to claim 10, wherein:
the second bus bar has a second contact bent downward from one edge thereof;
an upper portion of the second contact is embedded in the second terminal block; and
the second contact is electrically connected to a front lead tab of the second end battery cell.

12. The battery module according to claim 11, wherein the front sensing body further includes:
a first end guide rib guiding the front lead tab of the first end battery cell to the first contact; and
a second end guide rib guiding the front lead tab of the second end battery cell to the second contact.

13. The battery module according to claim 12, wherein:
the front sensing body further includes a plurality of middle guide ribs disposed between the first end guide rib and the second end guide rib; and
the plurality of front sensing bus bars are disposed between the plurality of middle guide ribs.

14. The battery module according to claim 1, wherein:
the rear sensing assembly has a plurality of snap fit locks extending toward the rear of the battery cell assembly; and
the snap fit locks of the plurality of snap fit locks are snap-fitted to rear hooks provided on the rear of the battery cell assembly, respectively.

15. The battery module according to claim 1, wherein the rear sensing assembly includes:
a rear sensing body;
a rear sensing PCB mounted on the rear sensing body;
a rear connector disposed on a central portion of the rear sensing PCB; and
a plurality of rear sensing bus bars electrically connected to the rear sensing PCB and the plurality of battery cells.

16. The battery module according to claim 15, wherein the rear sensing body includes a rear roof portion located above the rear sensing PCB, and wherein the rear roof portion fully covers a top surface of the rear connector.

17. The battery module according to claim 15, wherein the rear sensing body includes a plurality of guide ribs guiding rear lead tabs of the plurality of battery cells, and wherein the plurality of rear sensing bus bars are disposed between the plurality of guide ribs.

18. The battery module according to claim 1, wherein:
the front cover is coupled to the front end of the battery cell assembly to cover at least a portion of the front sensing assembly;
the front cover has a plurality of snap fit locks extending toward the front of the battery cell assembly; and
the snap fit locks of the plurality of snap fit locks are snap-fitted to front hooks provided on the front of the battery cell assembly, respectively.

19. The battery module according to claim 1, wherein:
the rear cover is coupled to the rear end of the battery cell assembly to cover at least a portion of the rear sensing assembly;
the rear cover has a plurality of snap fit locks extending toward the rear of the battery cell assembly; and
the snap fit locks of the plurality of snap fit locks are snap-fitted to rear hooks provided on the rear of the battery cell assembly, respectively.

20. The battery module according to claim 1, wherein the front cover has a groove receiving a voltage sensing wire connected to the front sensing assembly.
